(19) United States
(12) Patent Application Publication
(10) Pub. No.: US 2024/0428354 A1
(43) Pub. Date: Dec. 26, 2024

(54) INTELLIGENT VALUATION OF ARTIFICIAL INTELLIGENCE PROCESSING IN A LEGAL SERVICES PLATFORM

(71) Applicant: Micro Electric Inc., St. Petersburg, FL (US)

(72) Inventor: Euwyn Poon, New York, NY (US)

(21) Appl. No.: 18/212,531

(22) Filed: Jun. 21, 2023

(51) Int. Cl. G06Q 50/18; G06F 40/40; G06Q 30/04

(52) U.S. Cl. CPC G06Q 50/18; G06F 40/40; G06Q 30/04

(57) ABSTRACT

Methods and systems provide for determining cost values associated with artificial intelligence (AI) processing within a legal services platform. In one embodiment, the system receives a request for AI processing from a user, wherein the request comprises a quantity value associated with the AI processing; performs the AI processing to generate output based on the request; estimates a processing metric for the quantity value associated with the AI processing, wherein the processing metric comprises a value indicative of the amount of processing performed; determines a cost value based on the modified processing metric, wherein the cost value reflects the cost associated with the AI processing; and provides the cost value to the user for billing purposes in relation to the AI processing.

### FIELD OF INVENTION

The present invention relates generally to legal services, and more particularly, to systems and methods for providing valuation of artificial intelligence processing in a legal services platform.

### SUMMARY

The appended claims may serve as a summary of this application.

### BRIEF DESCRIPTION OF THE DRAWINGS

The present invention relates generally to digital communication, and more particularly, to systems and methods providing for presenting the results of talking speed analysis per topic segment in a communication session.

The present disclosure will become better understood from the detailed description and the drawings, wherein:

FIG. 1 is a diagram illustrating an exemplary environment in which some embodiments may operate.

FIG. 2 is a diagram illustrating an exemplary computer system that may execute instructions to perform some of the methods herein.

FIG. 3 is a flow chart illustrating an exemplary method that may be performed in some embodiments.

FIG. 4 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

The legal profession has long faced the challenge of balancing efficiency and productivity with the traditional model of billable hours. Lawyers often strive to streamline their work processes, yet they are constrained by the need to bill clients based on the time spent on each task. This dynamic has created a tension between lawyers' desire for efficiency and the financial incentives tied to billable hours, leading to inefficiencies and suboptimal outcomes for both lawyers and their clients.

In an effort to improve efficiency, various technologies and platforms have been developed to assist lawyers in their work. Legal research platforms like Westlaw and Nexis have revolutionized the process of retrieving legal information and precedents, enabling lawyers to access a vast repository of legal knowledge. However, these platforms typically operate on a subscription or pay-per-use basis, requiring lawyers to incur additional costs to provide the research services to their clients.

While these existing platforms offer valuable resources, they fail to fully address the need for efficient, cost-effective legal services. Lawyers still struggle to accurately track and bill for the time spent utilizing these tools, resulting in potential revenue losses and suboptimal pricing models. Moreover, the existing solutions do not provide a comprehensive mechanism for estimating the value and efficiency gained through the use of artificial intelligence (AI) and language models in legal work.

To overcome these limitations, there is a need in the field of legal services to create a new and useful system for intelligent valuation of AI processing in a legal services platform. There is a current need for an approach that aligns the incentives of lawyers and clients while accurately measuring and billing for the value generated by AI and language models. By utilizing a tool for valuation and billing that integrates AI capabilities, lawyers would be able to benefit from the efficiencies offered by AI while accurately attributing the value to their clients. This approach seeks to redefine billing structures where lawyers make use of AI tools for completing legal tasks, and enables lawyers to deliver high-quality legal services more efficiently and at a fair cost.

In one embodiment, the system receives a request for AI processing from a user, wherein the request comprises a quantity value associated with the AI processing; performs the AI processing to generate output based on the request; estimates a processing metric for the quantity value associated with the AI processing, wherein the processing metric comprises a value indicative of the amount of processing performed; determines a cost value based on the modified processing metric, wherein the cost value reflects the cost associated with the AI processing; and provides the cost value to the user for billing purposes in relation to the AI processing.

Further areas of applicability of the present disclosure will become apparent from the remainder of the detailed description, the claims, and the drawings. The detailed description and specific examples are intended for illustration only and are not intended to limit the scope of the disclosure.

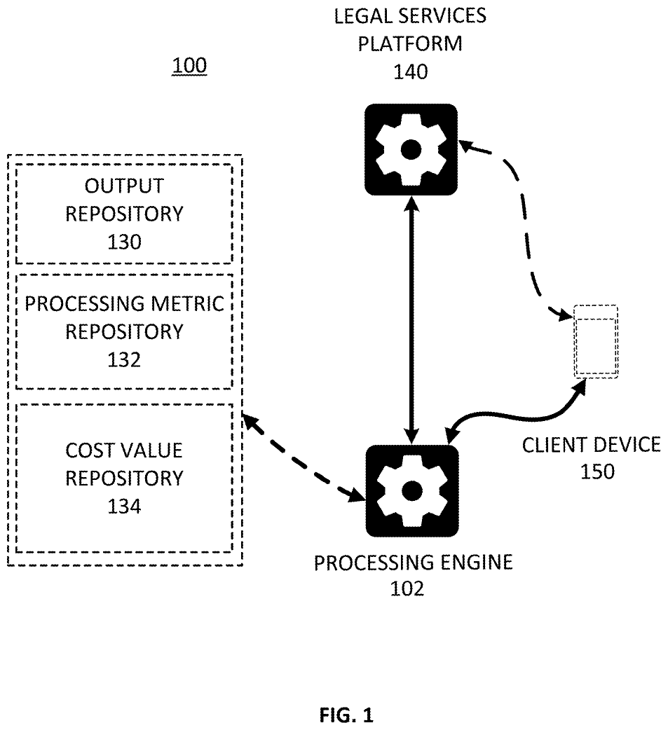

FIG. 1 is a diagram illustrating an exemplary environment in which some embodiments may operate. In the exemplary environment 100, a client device 150 is connected to a processing engine 102 and, optionally, a legal services platform 140. The processing engine 102 is connected to the legal services platform 140, and optionally connected to one or more repositories and/or databases, including, e.g., an output repository 130, processing metric repository 132, and/or a cost value repository 134. One or more of the databases may be combined or split into multiple databases. The user's client device 150 in this environment may be a computer, and the legal services platform 140 and processing engine 102 may be applications or software hosted on a computer or multiple computers which are communicatively coupled via remote server or locally.

The exemplary environment 100 is illustrated with only one client device, one processing engine, and one legal services platform, though in practice there may be more or fewer additional client devices, processing engines, and/or legal services platforms. In some embodiments, the client device(s), processing engine, and/or legal services platform may be part of the same computer or device.

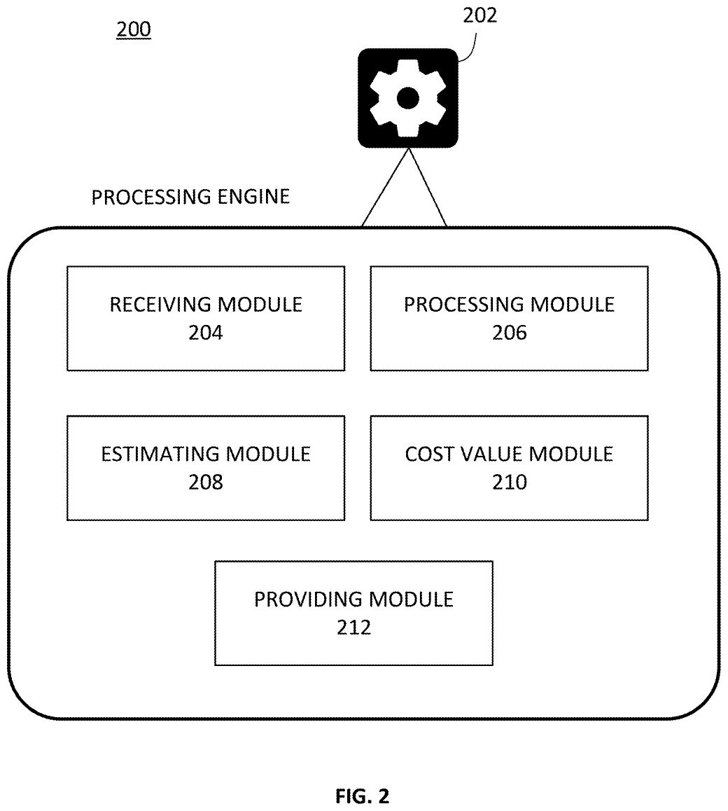

In an embodiment, the processing engine 102 may perform the exemplary method of FIG. 2 or other method herein and, as a result, determine and provide a cost value associated with AI processing within a legal services platform. In some embodiments, this may be accomplished via communication with the client device, processing engine, legal services platform, and/or other device(s) over a network between the device(s) and an application server or some other network server. In some embodiments, the processing engine 102 is an application, browser extension, or other piece of software hosted on a computer or similar device, or is itself a computer or similar device configured to host an application, browser extension, or other piece of software to perform some of the methods and embodiments herein.

The client device 150 is a device with a display configured to present information to a user of the device who is a user of the legal services platform. In some embodiments, the client device presents information in the form of a visual UI with multiple selectable UI elements or components. In some embodiments, the client device 150 is configured to send and receive signals and/or information to the processing engine 102 and/or legal services platform 140. In some embodiments, the client device is a computing device capable of hosting and executing one or more applications or other programs capable of sending and/or receiving information. In some embodiments, the client device may be a computer desktop or laptop, mobile phone, virtual assistant, virtual reality or augmented reality device, wearable, or any other suitable device capable of sending and receiving information. In some embodiments, the processing engine 102 and/or legal services platform 140 may be hosted in whole or in part as an application or web service executed on the client device 150. In some embodiments, one or more of the legal services platform 140, processing engine 102, and client device 150 may be the same device. In some embodiments, the user's client device 150 is associated with a first user account within a legal services platform, and one or more additional client device(s) may be associated with additional user account(s) within the legal services platform.

In some embodiments, optional repositories can include, e.g., an output repository 130, processing metric repository 132, and/or a cost value repository 134, which respectively function to provide repositories for obtaining outputs or results from one or more AI models; processing metrics indicative of the amount and nature of AI processing performed for various outputs; and cost values reflective of the cost associated with the AI processing for various tasks.

The legal services platform 140 represents a software-based system designed to facilitate and streamline legal processes, tasks, and workflows. The legal services platform acts as a digital workspace for legal professionals, providing them with a range of tools, resources, and functionalities to enhance their efficiency and productivity. In various embodiments, the legal services platform encompasses a variety of components and modules that support different aspects of legal work. It may include features such as, for example, document management, legal research, case management, contract analysis, drafting and collaboration tools, and communication channels tailored specifically for legal professionals. In various embodiments, these functionalities of the legal services platform may be accessible by users through, for example, web-based interfaces or dedicated software applications.

Within the legal services platform, users can interact with AI-powered tools and services to assist them in various legal tasks. In various embodiments, these AI capabilities can range from natural language processing techniques to large language models that offer advanced language understanding and generation capabilities. In some embodiments, the AI processing within the platform may leverage one or more of these technologies to provide intelligent and automated support for tasks such as, e.g., legal document generation, contract review, legal research, and more.

In some embodiments, the legal services platform may integrate with existing legal databases, knowledge repositories, and external data sources to enhance the quality and accuracy of the AI processing. In some embodiments, it may also incorporate machine learning algorithms that continuously learn from user interactions and feedback to improve the output of the AI processing.

FIG. 2 is a diagram illustrating an exemplary computer system 150 with software modules that may execute some of the functionality described herein. In some embodiments, the modules illustrated are components of the processing engine 102.

Receiving module 204 functions to receive a request for AI processing from a user, wherein the request indicates a quantity value associated with the AI processing.

Processing module 206 functions to perform the AI processing to generate output based on the request.

Estimating module 208 functions to estimate a processing metric for the quantity value associated with the AI processing, where the processing metric reflects a value indicative of the amount and nature of the AI processing performed.

Cost value module 210 functions to determine a cost value based on the processing metric, where the cost value reflects the cost associated with the AI processing.

Providing module 212 functions to provide the cost value to the user for billing purposes in relation to the AI processing.

The above modules and their functions will be described in further detail in relation to an exemplary method below.

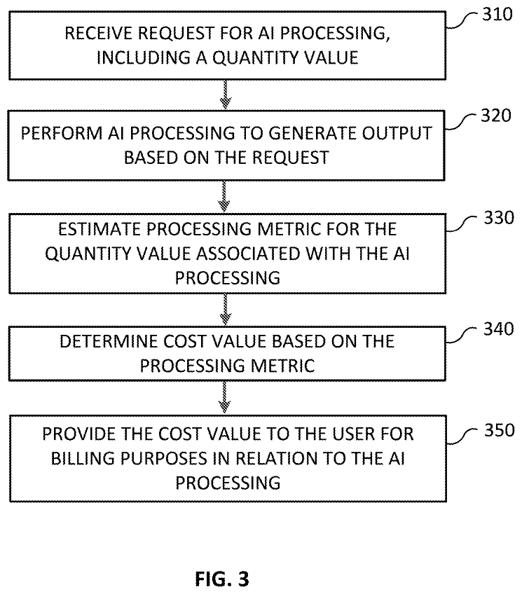

FIG. 3 is a flow chart illustrating an exemplary method that may be performed in some embodiments.

At step 310, the system receives a request for AI processing from a user, wherein the request comprises a quantity value associated with the AI processing.

In some embodiments, the system first establishes a connection to a legal services platform. In some embodiments, the connection includes opening a communication channel between a client device associated with a user and the legal services platform. In some embodiments, once the connection is established, users can submit their requests for AI processing. Users of the legal services platform, which can include, e.g., lawyers or other legal professionals, interact with the legal services platform to seek assistance in performing specific tasks or generating legal content.

In some embodiments, the request made by the user encompasses a quantity value that holds significant relevance to the AI processing involved. The quantity value serves as a representation of the desired scope, extent, and/or complexity of the AI processing required. It can be expressed in various forms, depending on the specific context or requirements of the task. For example, in the legal domain, the quantity value could indicate the length of the document to be generated, the number of clauses to be drafted, or the level of analysis needed for a particular legal issue.

In some embodiments, when the user submits the request, the system receives and processes it, extracting the quantity value associated with the AI processing. This quantity value acts as a crucial input parameter for subsequent steps in the method. In some embodiments, the quantity value allows the system to understand the user's expectations regarding the scale or magnitude of the AI processing task. In some embodiments, the quantity value enables the system to estimate the appropriate resources required to fulfill the request. By incorporating the quantity value within the request, the method ensures that the AI processing can be tailored to meet the specific needs and preferences of the user. It further enables the system to provide accurate estimations, both in terms of the processing effort required and the associated cost value.

In some embodiments, the system incorporates a graphical user interface (GUI) as the user interface for the request. In some embodiments, the GUI may provide a visual and interactive platform that enables users to input their requests and view the estimated cost value associated with the AI processing. In various embodiments, the GUI may include one or more of, e.g., input fields, dropdown menus, checkboxes, or other interactive elements that facilitate the specification of the desired AI processing. In some embodiments, users can provide details, parameters, or specific instructions related to the task they want the AI system to perform.

In some embodiments, once the user has inputted the request, the GUI interacts with the system to process the request and estimate the cost value associated with the AI processing. The estimated cost value is then displayed within the GUI, providing the user with immediate visibility into the potential cost implications of their request. In various embodiments, the GUI may include one or more additional elements or features, such as, e.g., an ability for the user to customize or refine the request based on the estimated cost value. In some embodiments, users may interact with the GUI to, for example, modify parameters, adjust complexity levels, or explore alternative options.

In some embodiments, the GUI additionally or alternatively provides a metrics dashboard for users to access comprehensive information about their requests as well as their associated processing metrics and cost values. In some embodiments, the metrics dashboard serves as a centralized page or section within the GUI where users can gain insights into their usage of the AI processing within the legal services platform. It may present, for example, a collection of relevant metrics that offer an overall view of the user's interaction with the system, including, e.g., the performance, efficiency, and financial aspects of their requests.

In various embodiments, the metrics displayed in the dashboard may include one or more of, for example, processing metrics, cost values, time spent on different requests, accuracy rates, and/or productivity indicators. These metrics may be derived from the AI processing performed on the user's requests. In some embodiments, users may be able to navigate through the metrics dashboard and explore different visualizations, charts, or tables that present the metrics in an easily understandable format. In various embodiments, users may be able to filter, sort, or drill down into specific metrics or time periods to gain deeper insights and identify patterns or trends in their AI utilization.

At step 320, the system performs the AI processing to generate output based on the request.

In some embodiments, the AI processing generates a legal work product output. That is, within the legal services platform, the output generated by the AI processing takes the form of and represents a legal work product that is intended to be relevant and useful for legal professionals.

The legal work product output can potentially encompass a wide range of materials and documents commonly utilized in legal practice. In various embodiments, this may include one or more of, e.g., draft contracts, legal memos, research summaries, legal opinions, or other forms of legal analysis. In some embodiments, the AI processing leverages its capabilities, such as, e.g., understanding legal concepts, analyzing textual information, and retrieving relevant legal knowledge, to generate output that aligns with the standards and requirements of legal work products.

In some embodiments, once the system receives the user's request for AI processing, the system proceeds to execute the necessary computational operations to perform the AI processing. In various embodiments, the system may leverage, e.g., advanced algorithms, machine learning models, specialized and/or generalized language models, and/or natural language processing techniques to analyze and interpret the input provided by the user. In some embodiments, the system applies one or more sophisticated computational methodologies to understand the context, intent, and/or specific requirements embedded within the user's request. Based on this comprehensive analysis, the system generates the desired output, which is specifically tailored to address the user's needs and preferences.

During the AI processing stage, the system utilizes its computational capabilities to efficiently and accurately process the user's request. In various embodiments, the system may employ one or more sophisticated techniques such as, e.g., pattern recognition, language modeling, and/or data analysis to transform the user's input into meaningful and valuable output. The AI processing takes into account various factors, including the quantity value associated with the request, to ensure that the generated output meets the desired criteria and fulfills the user's expectations.

In some embodiments, the performance of the AI processing involves the system's ability to leverage vast amounts of, e.g., data, training models, and/or knowledge repositories. The system may apply one or more AI models and/or methodologies to extract insights, make informed decisions, and generate high-quality output. The system may utilize, e.g., pre-existing templates, legal databases, or proprietary knowledge bases to enhance the accuracy, relevance, and/or efficiency of the output generation process.

In some embodiments, the system performs the AI processing by specifically utilizing a large language model (hereinafter “LLM”) as the underlying technology. Large language models may include AI models that have been trained on large amounts of text data, enabling them to generate human-like responses and provide contextually relevant information. By incorporating LLMs into the AI processing, the generated output may be an improvement over other forms of AI processing due to, for example, a perceived facility with natural language, legal terminology, concepts and tasks, and/or coherent and contextually appropriate responses. For example, attorneys and other users interacting with the legal services platform may be able to make requests and submit prompts using natural language, similar to communicating with a human counterpart.

In some embodiments, this LLM-based AI processing may enable a wide range of legal tasks to be efficiently performed, such as, for example, drafting legal clauses, providing legal research summaries, or generating a variety of agreements and contracts for different contexts, situations, and client needs. In some embodiments, an LLM may be configured to analyze the input request, retrieve relevant legal knowledge and precedents, and generate output that assists the user in their legal work.

In some embodiments, the estimation of the processing metric and the subsequent determination of the cost value may take into account this utilization of LLMs. Factors such as, e.g., the complexity of the language, customization of the generated output, and the computational effort required by the LLM inference process may be considered when estimating the processing metric.

In some embodiments, the AI processing includes the use of natural language processing (hereinafter “NLP”) techniques to generate the output. The NLP techniques can involve various processes, such as, e.g., syntactic analysis, semantic understanding, language modeling, and text generation. These techniques enable the AI system to effectively interpret the user's request, generate accurate and contextually relevant output, and ensure that the generated content aligns with the natural flow and structure of human language.

At step 330, the system estimates a processing metric for the quantity value associated with the AI processing. The processing metric includes a value indicative of the amount and nature of the AI processing performed.

In some embodiments, the system quantifies and characterizes the AI processing carried out by the system. This estimation may involve determining a processing metric that provides valuable information about both the extent and nature of the AI processing performed.

After receiving the user's request and performing the AI processing, the system proceeds to estimate a processing metric that accurately reflects the quantity value associated with the AI processing. The processing metric serves as a quantitative measure that gauges the scope and intensity of the AI processing carried out by the system.

To estimate the processing metric, the system takes into account various factors, including the complexity of the user's request, the computational resources utilized, and the computational operations performed during the AI processing. The system may analyze the input data, the number of computational steps executed, or the computational time required to complete the AI processing.

The processing metric provides insights into the amount of work performed by the AI system, offering a quantifiable indicator of the computational effort expended. It captures the level of sophistication, depth, and intricacy involved in the AI processing. For instance, in the legal domain, the processing metric may reflect the degree of legal analysis conducted, the level of language understanding and generation, or the complexity of the legal reasoning applied.

Moreover, the processing metric not only encompasses the quantity of AI processing but also provides information about the nature of the processing performed. This includes the specific techniques, algorithms, or models employed during the AI processing. For instance, the processing metric may indicate the use of, e.g., natural language processing, machine learning, deep learning, or other AI methodologies.

In some embodiments, estimating the processing metric for the quantity value comprises analyzing the text of the output generated by the AI processing. In some embodiments, this analysis involves the system analyzing the complexity of the language used in the request and the generated output to determine the level of linguistic and legal intricacy involved. In some embodiments, the estimation of the processing metric takes into account various factors that contribute to the complexity and value of the AI processing. By analyzing the complexity of the language in the request and the generated output, the system can evaluate the linguistic and/or legal intricacy involved, allowing for a more accurate assessment of the amount of effort and expertise required for the AI processing.

In some embodiments, the analysis may involve assessing the utilization of one or more predefined templates for outputs and/or requests, including, for example, measuring the variance of outputs or requests from existing templates of outputs or requests, in order to evaluate the extent of customization and complexity in the AI processing. This analysis may enable the determination of the level of customization and complexity involved in the AI processing. In some embodiments, the system may additionally or alternatively factor in that the adaptation of existing templates or the creation of unique content for an output in response to a request may require additional effort and expertise, which should be reflected in the estimation of the processing metric and the resulting cost value.

In some embodiments, the system may combine these various factors, thereby determining a comprehensive processing metric that reflects the quantity value associated with the AI processing. This processing metric may incorporate considerations of, e.g., linguistic and legal complexity, customization of content, and the computational effort involved. By considering these factors, the method provides a more accurate estimation of the value and cost associated with the AI processing, leading to fair and transparent billing practices.

In some embodiments, the processing metric is adjusted via the application of one or more weighted percentages. In some embodiments, the weighted percentages allow for the fine-tuning and customization of the processing metric, ensuring that it accurately reflects the value and cost associated with the AI processing performed within the legal services platform. In some embodiments, the weighted percentages serve as modifiers that may adjust the processing metric based on specific considerations deemed relevant by the legal services platform or its users. These considerations may include, e.g., factors such as the priority level of the request, the level of expertise required for the AI processing, or the degree of customization and tailored output provided by the AI processing. In some embodiments, by applying the weighted percentages to the processing metric, the method allows for the subjective and context-specific factors to be taken into account during the cost estimation process. This customization ensures that the cost value aligns with the specific circumstances of the AI processing and accurately reflects the effort, expertise, and value involved.

In some embodiments, the weighted percentages can be determined through, e.g., iterative refinement and optimization based on user feedback, industry standards, or other predefined criteria. In some embodiments, the legal services platform may provide flexibility in adjusting and adapting the weighted percentages to suit different types of AI processing or specific user preferences, allowing for a more precise and tailored cost estimation.

In some embodiments, the system takes into account a time component of the AI processing. By analyzing the duration of the inference process, which is directly related to the complexity of the inference performed by the AI, the method accounts for the computational effort and resources expended during the processing. This time-based analysis may provide an additional dimension for estimating the processing metric and helps ensure that the cost value accurately represents the resources utilized. In some embodiments, the system factors into the estimation that more complex inferences require additional computational resources and time to process effectively. For example, the system may factor in that the complexity of the inference performed by the AI is directly proportional to the time required for the processing, such that as the complexity increases, the AI processing takes longer to complete, indicating that greater effort and computational resources are involved. Thus, as the AI processing encounters more intricate requests or performs advanced legal analyses, the time component proportionally reflects the increased computational effort, resulting in a more comprehensive processing metric.

In some embodiments, the system factors in that the quantity value associated with the AI processing is, at least in part, representative of the desired length or complexity of the output generated by the AI system. The quantity value can thus serve as a parameter that allows the user to specify their expectations regarding the output, providing a means to control and/or tailor the characteristics of the generated content. In some embodiments, by considering the quantity value as a measure of desired length or complexity, the system can adjust its processing and generation mechanisms accordingly. For example, if a user requests a longer or more complex output, the AI system can allocate additional resources and apply more advanced algorithms to fulfill the user's requirements. Conversely, for example, if a user desires a shorter or simpler output, the system can optimize its processing to generate concise and straightforward results.

In some embodiments, the estimation of the processing metric involves the system factoring in the number of words in the output generated by the AI processing. The number of words may serve as a quantifiable measure that reflects the extent and complexity of the generated content, allowing for an estimation of the resources expended during the AI processing. In some embodiments, by analyzing the number of words in the output, the system can infer one or more of, e.g., a level of detail, comprehensiveness, and/or information density of the generated content. For example, a larger number of words may indicate a more elaborate output requiring in-depth analysis, while a smaller number of words may suggest a more concise and focused result. By utilizing this information, the system can estimate the processing metric at least in part.

In some embodiments, the estimation of the processing metric includes assessing the accuracy or quality of the output generated by the AI processing. For example, by evaluating the accuracy or quality of the generated content, the system can gain insights into the level of precision and/or proficiency exhibited during the AI processing. In various embodiments, the assessment of accuracy or quality may involve various techniques and criteria. For example, in various embodiments, the system may, e.g., compare the output against known or desired standards, evaluate the consistency and coherence of the generated text, analyze the presence of errors or inconsistencies, or employ other quality assessment measures.

In some embodiments, the system utilizes a database of predetermined content or tables as a reference to evaluate the complexity of the output generated by the AI processing. The database may contain predefined content or tables that represent varying levels of complexity in legal work products or related materials. In some embodiments, the comparison process involves analyzing the similarities, patterns, or relationships between the generated output and the predetermined content or tables. This evaluation allows the system to determine the degree to which the generated content aligns with known complexity levels. For instance, if the output closely resembles or incorporates elements from highly complex legal documents or tables in the database, a higher complexity level in the generated content may be indicated.

At step 340, the system determines a cost value based on the processing metric. The cost value reflects the cost associated with the AI processing.

In some embodiments, the cost value is allocated as billable hours to be billed to a client for the AI processing. In some embodiments, the cost value associated with the AI processing is allocated as billable hours for the purpose of invoicing the client. In some embodiments, the system may specifically utilize a traditional billing model used in legal services, where billable hours are utilized to determine fees, such that this billing model is applied to the AI processing performed within the legal services platform.

In some embodiments, the system evaluates the processing metric and establishes the cost associated with the AI processing performed by the system. In some embodiments, this limitation involves calculating a cost value that accurately represents the financial implications of the AI processing.

Once the processing metric, which quantifies the amount and nature of the AI processing, is determined, the system proceeds to calculate a corresponding cost value. The cost value represents the monetary expense or financial consideration associated with the AI processing performed by the system.

In some embodiments, to determine the cost value, the system can take into account one or more factors, including the processing metric, the computational resources utilized, and the specific cost structure established for the AI services. The cost value calculation may involve applying a predetermined rate per unit of the processing metric or using a dynamic pricing model based on the complexity, time, or resources utilized during the AI processing.

In some embodiments, the cost value reflects the value and effort expended by the system in providing the AI processing services. The cost value can take into consideration factors such as, e.g., the computational resources, expertise, and/or infrastructure required to execute the AI algorithms and models. Additionally, the cost value may also account for other overhead costs, such as, e.g., maintenance, updates, or licensing fees associated with the AI technologies employed.

In some embodiments, by determining the cost value, the system can provide users with transparent and accurate pricing information for the AI processing services rendered. This enables users to understand the financial implications of utilizing the system and assists them in making informed decisions regarding cost allocation and budgeting. The cost value ensures that the AI processing services are aligned with the economic considerations and expectations of the users.

In some embodiments, the cost value can be further adjusted or customized based on additional factors or considerations. These may include, e.g., client-specific requirements, urgency of the request, complexity of the legal matter, or other relevant parameters. The system may incorporate a flexible pricing structure that allows for adjustments based on specific circumstances, ensuring fairness and relevance in the cost determination process.

In some embodiments, the system incorporates a predetermined rate per unit of the processing metric to determine the cost value associated with the AI processing. In some embodiments, the processing metric, which represents the amount and nature of the AI processing performed, may serve as a quantifiable measure that can be converted into cost values using the predetermined rate. In some embodiments, the predetermined rate per unit of the processing metric reflects the value assigned to each unit of processing performed by the AI system. In various embodiments, this rate can be set based on various factors such as, e.g., the complexity of the task, the expertise required, or the market standards. For example, a more intricate or time-consuming task may have a higher predetermined rate per unit, while a simpler or quicker task may have a lower rate.

At step 350, the system provides the cost value to the user for billing purposes in relation to the AI processing.

In some embodiments, the system communicates the determined cost value to the user. This step serves the purpose of facilitating billing and financial transactions related to the AI processing services rendered. Here is a detailed description of this limitation:

Once the cost value associated with the AI processing is determined, the system proceeds to provide this cost value to the user for billing purposes. The cost value represents the financial amount that the user is required to pay for the AI processing services received.

The system communicates the cost value to the user through a suitable medium, such as a user interface, invoice, or electronic notification. This communication includes a clear breakdown of the cost value, including any itemized charges, rates, or additional fees that may be relevant to the billing process. The information provided enables the user to understand the cost breakdown and facilitates accurate financial transactions.

By providing the cost value to the user, the system ensures transparency and accountability in the billing process. Users receive a clear and concise representation of the financial obligation associated with the AI processing services. This allows users, such as lawyers or legal professionals, to effectively allocate costs, track expenses, and manage their financial records.

Furthermore, the system may provide additional details or documentation supporting the cost value provided. This may include a summary of the AI processing performed, the processing metric used for cost determination, and any relevant terms or conditions related to the billing process. Such information ensures that users have a comprehensive understanding of the cost value and can reconcile it with the services received.

The provision of the cost value to the user also serves as a basis for financial transactions between the user and the system or service provider. Users can utilize the communicated cost value to initiate payment processes, such as issuing invoices to clients or integrating the cost into their own billing systems. This seamless integration of the cost value into the user's billing workflow simplifies financial transactions and supports efficient accounting practices.

In some embodiments, the system further refines the request based on the estimated processing metric. In some embodiments, after receiving the request for AI processing and estimating the processing metric, the method allows for the adjustment and optimization of the request to enhance the AI processing and subsequent output. In some embodiments, the refinement process takes into account the estimated processing metric, which provides valuable insights into the nature and complexity of the AI processing required. By analyzing the processing metric, the method can identify areas for improvement or modification in the original request to optimize the AI processing and generate more accurate and valuable output.

In various embodiments, the refinement of the request may involve various actions, such as, e.g., clarifying ambiguous language, providing additional context or specifications, or suggesting modifications to align the request with predefined templates or best practices. This iterative refinement process allows for the continuous improvement of the request and the subsequent AI processing, ensuring optimal results and maximizing the value provided to the user. In some embodiments, by refining the request based on the estimated processing metric, the system may facilitate a feedback loop that iteratively enhances the quality and effectiveness of the AI processing within the legal services platform. This iterative refinement process may function to improve the accuracy and relevance of the generated output, as well as further personalize the output and tailor it to the specific needs and objectives of the user.

In some embodiments, the AI processing is integrated as part of a pass-through billable service within the legal services platform, similar to existing pass-through services such as, e.g., Westlaw or Nexis. The pass-through billable service model allows the legal professionals utilizing the AI processing to incorporate the cost associated with the AI processing into their billing to clients. In some embodiments, the system employs a mechanism to determine the cost value based on the processing metric, as described in the steps above. This ensures that the AI processing expenses are appropriately allocated to clients.

In some embodiments, the system incorporates the ability to adjust the determined cost value based on external factors that are relevant to the specific legal matter and the client's requirements. These external factors may include one or more of: client-specific requirements, the urgency of the request, and/or the complexity of the legal matter at hand.

Client-specific requirements may vary from client to client and can influence the cost value associated with the AI processing. For example, certain clients may have specific demands or expectations that require additional resources or customization, leading to an adjustment in the cost value. The system takes into account these client-specific requirements to ensure accurate and tailored billing for each individual client.

The urgency of the request may also play a role in determining the adjusted cost value. Time-sensitive requests that require expedited processing may involve additional efforts or resources, leading to an adjustment in the cost value. The system considers the urgency of the request to provide appropriate billing that aligns with the time constraints and prioritization of the legal matter.

The complexity of the legal matter may also impact the adjusted cost value. For example, more complex legal matters may require a higher level of expertise, extensive research, or specialized resources, which can result in an adjustment to the cost value. The system takes into account the complexity of the legal matter to ensure that the billing accurately reflects the level of effort and resources invested in addressing the complexity.

In some embodiments, the system incorporates a database to store the relevant information associated with each request, including one or more of, for example, the user's input request, the estimated processing metric, and the determined cost value. This database serves as a repository of data that can be accessed and utilized for subsequent sessions within the legal services platform. In some embodiments, once the request is processed and the processing metric and cost value are estimated and determined, these values are stored in the database and associated with the specific request and user. This ensures that the information is readily available for future reference and analysis. In subsequent sessions within the legal services platform, users can then access and view the stored information related to their requests. The system retrieves the relevant data from the database and presents it to the user in an accessible format within the platform's interface. In various embodiments, users can analyze the stored information to gain insights into their previous requests, understand the patterns in their usage, and/or evaluate the cost implications of their AI utilization over time. They can, for example, compare the estimated processing metrics and cost values across different sessions, track the progress of their engagements, and make data-driven decisions based on the historical data available. In some embodiments, users may additionally or alternatively have the option to, e.g., generate reports, visualize trends, or perform customized queries on the data within the legal services platform.

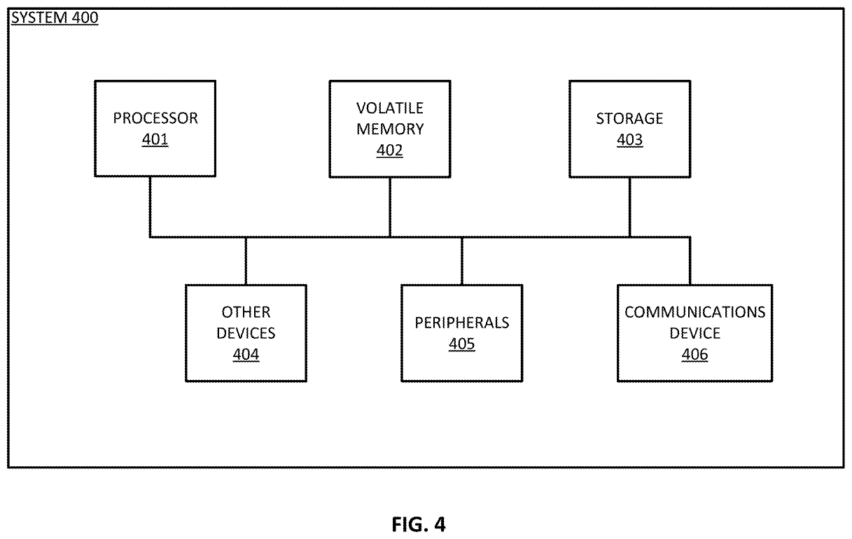

FIG. 4 is a diagram illustrating an exemplary computer that may perform processing in some embodiments. Exemplary computer 400 may perform operations consistent with some embodiments. The architecture of computer 400 is exemplary. Computers can be implemented in a variety of other ways. A wide variety of computers can be used in accordance with the embodiments herein.

Processor 401 may perform computing functions such as running computer programs. The volatile memory 402 may provide temporary storage of data for the processor 401. RAM is one kind of volatile memory. Volatile memory typically requires power to maintain its stored information. Storage 403 provides computer storage for data, instructions, and/or arbitrary information. Non-volatile memory, which can preserve data even when not powered and including disks and flash memory, is an example of storage. Storage 403 may be organized as a file system, database, or in other ways. Data, instructions, and information may be loaded from storage 403 into volatile memory 402 for processing by the processor 401.

The computer 400 may include peripherals 405. Peripherals 405 may include input peripherals such as a keyboard, mouse, trackball, video camera, microphone, and other input devices. Peripherals 405 may also include output devices such as a display. Peripherals 405 may include removable media devices such as CD-R and DVD-R recorders/players. Communications device 406 may connect the computer 100 to an external medium. For example, communications device 406 may take the form of a network adapter that provides communications to a network. A computer 400 may also include a variety of other devices 404. The various components of the computer 400 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method for determining cost values associated with artificial intelligence (AI) processing within a legal services platform, comprising:
receiving a request for AI processing from a user, wherein the request comprises a quantity value associated with the AI processing;
performing the AI processing to generate output based on the request;
estimating a processing metric for the quantity value associated with the AI processing, wherein the processing metric comprises a value indicative of the amount and nature of the AI processing performed;
determining a cost value based on the processing metric, wherein the cost value reflects the cost associated with the AI processing; and
providing the cost value to the user for billing purposes in relation to the AI processing.

2. The method of claim 1, wherein estimating the processing metric for the quantity value comprises analyzing the text of the output generated by the AI processing.

3. The method of claim 1, wherein estimating the processing metric for the quantity value comprises assessing the complexity of the output generated by the AI processing.

4. The method of claim 1, wherein estimating the processing metric for the quantity value comprises comparing the output generated by the AI processing with one or more templates.

5. The method according to claim 1, wherein the AI processing comprises utilizing a large language model (LLM).

6. The method according to claim 1, wherein the processing metric is adjusted via one or more weighted percentages.

7. The method according to claim 1, further comprising:
refining the request based on the estimated processing metric.

8. The method according to claim 1, wherein the AI processing includes a time component, and wherein the estimating of the processing metric is configured such that the time component is proportional to the complexity of the inference performed by the AI processing.

9. The method according to claim 1, wherein the output generated by the AI processing comprises a legal work product output.

10. The method according to claim 1, wherein the cost value is allocated as billable hours to be billed to a client for the AI processing.

11. The method according to claim 1, wherein the AI processing is utilized as part of a pass-through billable service.

12. A system for determining cost values associated with AI processing within a legal services platform, the system comprising one or more processors configured to perform the operations of:
receiving a request for AI processing from a user, wherein the request comprises a quantity value associated with the AI processing;
performing the AI processing to generate output based on the request;
estimating a processing metric for the quantity value associated with the AI processing, wherein the processing metric comprises a value indicative of the amount and nature of the AI processing performed;
determining a cost value based on the processing metric, wherein the cost value reflects the cost associated with the AI processing; and
providing the cost value to the user for billing purposes in relation to the AI processing.

13. The system of claim 12, wherein the AI processing further comprises generating the output by utilizing natural language processing techniques.

14. The system of claim 12, wherein the quantity value associated with the AI processing represents a desired length or complexity of the output.

15. The system of claim 12, wherein the processing metric is estimated based at least in part on the number of words in the output generated by the AI processing.

16. The system of claim 12, wherein the processing metric is estimated based at least in part on the complexity of the language used in the output generated by the AI processing.

17. The system of claim 12, wherein the processing metric is estimated based at least in part on assessing the accuracy or quality of the output generated by the AI processing.

18. The system of claim 12, wherein the output generated by the AI processing is compared with a database of predetermined content or tables to determine the complexity of the output.

19. The system of claim 12, wherein the cost value is determined at least in part by applying a predetermined rate per unit of the processing metric.

20. The system of claim 12, further comprising:
adjusting the determined cost value based on one or more external factors, wherein the external factors comprise at least one of: client-specific requirements, urgency of the request, and complexity of the legal matter.

21. The system of claim 12, wherein the user interface for the request comprises a graphical user interface (GUI) enabling the user to input the request and view the estimated cost value.

22. The system of claim 21, wherein the GUI further enables the user to view a metrics dashboard configured to display one or more metrics relating to requests associated with the user and their corresponding processing metrics and cost values.

23. The system of claim 12, wherein the request, the estimated processing metric, and the determined cost value are stored in a database and displayed in one or more subsequent sessions of the legal services platform for the user to view and analyze.

24. A non-transitory computer-readable medium for determining cost values associated with AI processing within a legal services platform, comprising:
instructions for receiving a request for AI processing from a user, wherein the request comprises a quantity value associated with the AI processing;
instructions for performing the AI processing to generate output based on the request;
instructions for estimating a processing metric for the quantity value associated with the AI processing, wherein the processing metric comprises a value indicative of the amount and nature of the AI processing performed;
instructions for determining a cost value based on the processing metric, wherein the cost value reflects the cost associated with the AI processing; and
instructions for providing the cost value to the user for billing purposes in relation to the AI processing.
